(19) United States
(12) Patent Application Publication
(10) Pub. No.: US 2019/0264569 A1
(43) Pub. Date: Aug. 29, 2019

(54) TURBINE ROTOR BLADE WITH EXITING HOLE TO DELIVER FLUID TO BOUNDARY LAYER FILM

(71) Applicant: General Electric Company, Schenectady, NY (US)

(72) Inventors: Moorthi Subramaniyan, Bangalore (IN); Adam John Fredmonski, Simpsonville, SC (US)

(21) Appl. No.: 15/903,192

(22) Filed: Feb. 23, 2018

(51) Int. Cl. F01D 5/14; F01D 5/18

(52) U.S. Cl. CPC F01D 5/145; F02C 3/04; F01D 5/186

(57) ABSTRACT

A turbine blade including an airfoil extending radially from a platform above a shank is disclosed. The airfoil has a leading edge; a trailing edge; and a pressure side wall and a suction side wall extending between the leading edge and trailing edge. The turbine blade includes a chamber in at least one of the airfoil and platform. The chamber is configured to deliver a first fluid therein having a higher pressure than a second fluid in a wheel space adjacent the shank. The turbine blade includes an exiting hole in fluid communication with the chamber, positioned at a location upstream of the leading edge and circumferentially to a side of a selected side wall of the pressure side wall and suction side wall. In operation, the first fluid exits the exiting hole to increase a momentum of a boundary layer film near the selected side wall, preventing wheel space leakage from negatively impacting the boundary layer film.

### BACKGROUND OF THE INVENTION

The subject matter disclosed herein relates to turbine blades, and more specifically, to a turbine blade (rotor blade or vane) including an exiting hole to deliver a fluid to increase a momentum of a boundary layer film on an exterior surface of the turbine airfoil.

In a gas turbine engine, it is well known that air is pressurized in a compressor and used to combust a fuel in a combustor to generate a flow of hot combustion gases, whereupon such gases flow downstream through one or more turbines so that energy can be extracted therefrom. In accordance with such a turbine, generally, rows of circumferentially spaced turbine rotor blades extend radially outwardly from a supporting rotor disk. In addition, a number of stationary vanes extend radially inwardly from a supporting casing. Each rotor blade or vane typically includes a dovetail that permits assembly and disassembly of the blade in a corresponding dovetail slot in the rotor disk or casing, as well as an airfoil that extends radially outwardly or inwardly from the dovetail. A wheel space is created between shanks of adjacent blades or vanes. The airfoil has a generally concave pressure side wall and a generally convex suction side wall extending axially between corresponding leading and trailing edges and radially between a platform and a tip or another platform. It will be understood that the blade tip of a turbine rotor blade is spaced closely to a radially outer turbine shroud for minimizing leakage therebetween of the combustion gases flowing downstream between the turbine rotor blades, and a vane inner platform is spaced closely to a radially outer surface of the turbine rotor.

To prevent damage to the airfoil of the blade or vane, a cooling film is formed from various cooling passages across a surface of the airfoil, i.e., a boundary layer cooling flow. One challenge with creating an effective platform cooling film is the tendency for it to be swept away from airfoil platforms by endwall vortices that exist in turbomachines. These vortices sweep cool platform film generally from the pressure side of one blade to the suction side of an adjacent blade and then along the blade's suction surface in a direction radially away from the platform. Concurrently, much hotter mainstream flow migrates from the blade's pressure side toward the platform and then along the platform from the blade's pressure side to the suction side of an adjacent blade. This general movement of cool and hot boundary layer flows occurs with aerodynamic shear forces that also move the boundary layer flows in the general direction of the mainstream flow, that being in the direction from the leading edge to the trailing edge of the blade. This results in a lack of cooling flow coverage on the airfoil and the platform, and thereby increases the cooling flow requirements for the component

The wheel space between adjacent turbine rotor blades or vanes is also typically cooled by a coolant flow that discharges between adjacent turbine rotor blades or vanes. The coolant escaping from the wheel space presents another challenge in that it can cause the airfoil's platform boundary layer to become thicker and have reduced through-flow momentum. These conditions cause the endwall vortices to strengthen and penetrate radially further into the mainstream flowfield, resulting in considerably increased aerodynamic losses in addition to reduced airfoil/platform cooling effectiveness.

The increased aerodynamic losses and increased cooling flow requirements associated with endwall vortices negatively impact turbine performance by increasing the heat rate thereof and/or reducing thermodynamic efficiency.

### BRIEF DESCRIPTION OF THE INVENTION

A first aspect of the disclosure provides a turbine blade, including: an airfoil extending radially from a platform above a shank, the airfoil having a leading edge and a trailing edge, a pressure side wall extending between the leading edge and the trailing edge and a suction side wall extending between the leading edge and the trailing edge; a chamber in at least one of the airfoil and the platform, the chamber configured to deliver a first fluid therein having a higher pressure than a second fluid in a wheel space adjacent the shank; and an exiting hole in fluid communication with the chamber, the exiting hole at a location upstream of the leading edge and circumferentially to a side of a selected side wall of one of the pressure side wall or the suction side wall, wherein, in operation, the first fluid exits the exiting hole to increase a momentum of a boundary layer film near the selected side wall.

A second aspect of the disclosure provides a gas turbine system, including: a compressor; a combustor operatively coupled to the compressor; a gas turbine operatively coupled to the compressor and the combustor, the gas turbine including: a first turbine blade, the first turbine blade including: a first airfoil extending radially from a first platform and a first shank, the first airfoil having a leading edge and a trailing edge, a pressure side wall extending between the respective leading edge and trailing edge, and a suction side wall extending between the respective leading edge and trailing edge, a chamber in at least one of the first airfoil and the first platform, the chamber configured to deliver a first fluid therein, an exiting hole in fluid communication with the chamber, the exiting hole at a location upstream of the leading edge and circumferentially to a side of a selected side wall of one of the pressure side wall and the suction side wall; and a second turbine blade adjacent the first turbine blade, the second turbine blade including a second airfoil extending radially from a second platform above a second shank; and a wheel space between respective shanks of the first and second turbine blades, the wheel space having a second fluid therein having a pressure less than the first fluid, wherein, in operation, the second fluid escapes between the first platform and the second platform reducing a momentum of a boundary layer film near a selected side wall of the pressure side wall and the suction side wall, and the first fluid exits the exiting hole to increase the momentum of the boundary layer film near the selected side wall.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a schematic view of an illustrative turbomachine in the form of a gas turbine system.

FIG. 2 shows a cross-sectional view of an illustrative gas turbine assembly that may be used with the gas turbine system in FIG. 1.

FIG. 3 shows a perspective view of a turbine rotor blade including an airfoil of the type in which embodiments of the disclosure may be employed.

FIG. 4 shows a partial perspective view of a pair of turbine blades having an exiting hole according to embodiments of the disclosure.

FIG. 5 shows a perspective view of a pair of turbine blades having exiting holes according to other embodiments of the disclosure.

FIG. 6 shows a cross-sectional, perspective view of a platform of a turbine blade having exiting hole(s) according to embodiments of the disclosure.

FIG. 7 shows a cross-sectional, perspective view of a platform of a turbine blade having exiting hole(s) according to embodiments of the disclosure.

FIG. 8 shows a front view of a turbine blade including an airfoil having angled exiting hole(s) according to embodiments of the disclosure.

FIG. 9 shows a cross-sectional, perspective view of a turbine rotor blade having angled exiting hole(s) according to other embodiments of the disclosure.

FIG. 10 shows a perspective view of a turbine stationary vane including an airfoil of the type in which embodiments of the present disclosure may be employed.

It is noted that the drawings of the disclosure are not to scale. The drawings are intended to depict only typical aspects of the disclosure, and therefore should not be considered as limiting the scope of the disclosure. In the drawings, like numbering represents like elements between the drawings.

### DETAILED DESCRIPTION OF THE INVENTION

As an initial matter, in order to clearly describe the current disclosure it will become necessary to select certain terminology when referring to and describing relevant machine components within a gas turbine system. When doing this, if possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as being a single part may include and be referenced in another context as consisting of multiple components. Alternatively, what may be described herein as including multiple components may be referred to elsewhere as a single part. In addition, several descriptive terms may be used regularly herein, and it should prove helpful to define these terms at the onset of this section. These terms and their definitions, unless stated otherwise, are as follows. As used herein, “downstream” and “upstream” are terms that indicate a direction relative to the flow of a fluid, such as the working fluid through the turbine engine or the flow of boundary layer film from a leading edge toward a trailing edge of an airfoil. The term “downstream” corresponds to the direction of flow of the fluid, and the term “upstream” refers to the direction opposite to the flow. The terms “forward” and “aft,” without any further specificity, refer to directions, with “forward” referring to the front or compressor end of the engine, and “aft” referring to the rearward or turbine end of the engine. It is often required to describe parts that are at differing radial positions with regard to a center axis. The term “radial” refers to movement or position perpendicular to an axis. In cases such as this, if a first component resides closer to the axis than a second component, it will be stated herein that the first component is “radially inward” or “inboard” of the second component. If, on the other hand, the first component resides further from the axis than the second component, it may be stated herein that the first component is “radially outward” or “outboard” of the second component. The term “axial” refers to movement or position parallel to an axis. Finally, the term “circumferential” refers to movement or position around an axis. It will be appreciated that such terms may be applied in relation to the center axis of the turbine.

Where an element or layer is referred to as being “on,” “engaged to,” “disengaged from,” “connected to” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

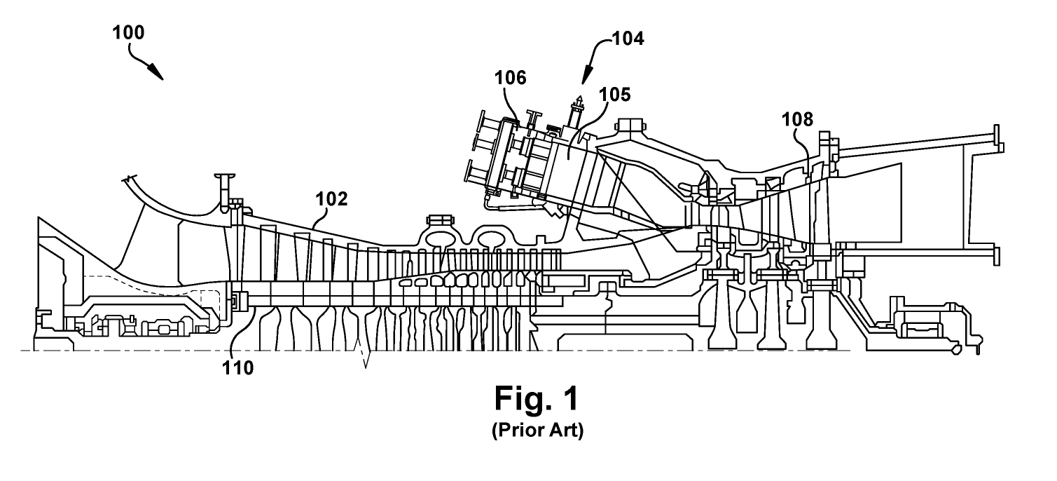

FIG. 1 is a schematic illustration of an illustrative turbomachine in the form of a gas turbine system 100. System 100 includes a compressor 102 and a combustor 104. Combustor 104 includes a combustion region 105 and a fuel nozzle assembly 106. System 100 also includes a gas turbine 108 and a common compressor/turbine rotor 110. In one embodiment, system 100 is a 7F model engine with an S1B tech package, commercially available from General Electric Company, Greenville, S.C. Embodiments of the disclosure are not limited to any one particular gas turbine engine, and may be implemented in connection with other engines including, for example, the 7FA and 9FA engine models of General Electric Company. Furthermore, teachings of the disclosure are not limited to gas turbines, and may be applied to any variety of turbomachine such as steam turbines, jet engines, compressors, etc.

In operation, air flows through compressor 102 and compressed air is supplied to combustor 104. Specifically, the compressed air is supplied to fuel nozzle assembly 106 that is integral to combustor 104. Assembly 106 is in fluid communication with combustion region 105. Fuel nozzle assembly 106 is also in fluid communication with a fuel source (not shown in FIG. 1) and channels fuel and air to combustion region 105. Combustor 104 ignites and combusts fuel. Combustor 104 is in fluid communication with gas turbine 108 for which gas stream thermal energy is converted to mechanical rotational energy. Gas turbine 108 is rotatably coupled to and drives rotor 110. Compressor 102 also is rotatably coupled to rotor 110. In the illustrative embodiment, there is a plurality of combustors 104 and fuel nozzle assemblies 106.

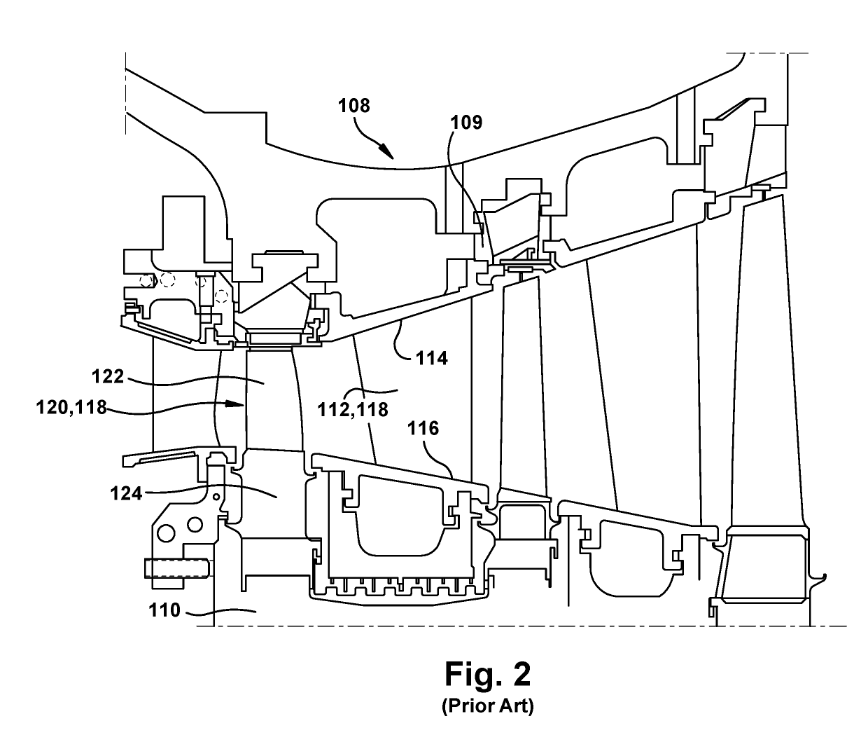

FIG. 2 is cross-section illustration of an illustrative gas turbine 108 with a three stage nozzle that may be used with gas turbine system 100 in FIG. 1. Gas turbine 108 includes stationary vanes 112. Stationary vanes 112 are held in gas turbine 108 by a radially outer platform 114 and a radially inner platform 116. Platforms 114, 116 may also be referred to herein as hubs. Gas turbine 108 also includes turbine rotor blades 120, each of which may include an airfoil 122 held to rotor 110 by a shank 124. Embodiments of the disclosure, as will be described, are equally applicable to turbine rotor blades 120 that are coupled to rotor 110, and to stationary vanes 112 coupled to a casing 109 (FIG. 2). For purposes of description, turbine rotor blades 120 and stationary vanes 112 will be collectively referred to as “turbine blades 118,” unless otherwise noted. Embodiments of the disclosure will be described first relative to a turbine rotor blade 120.

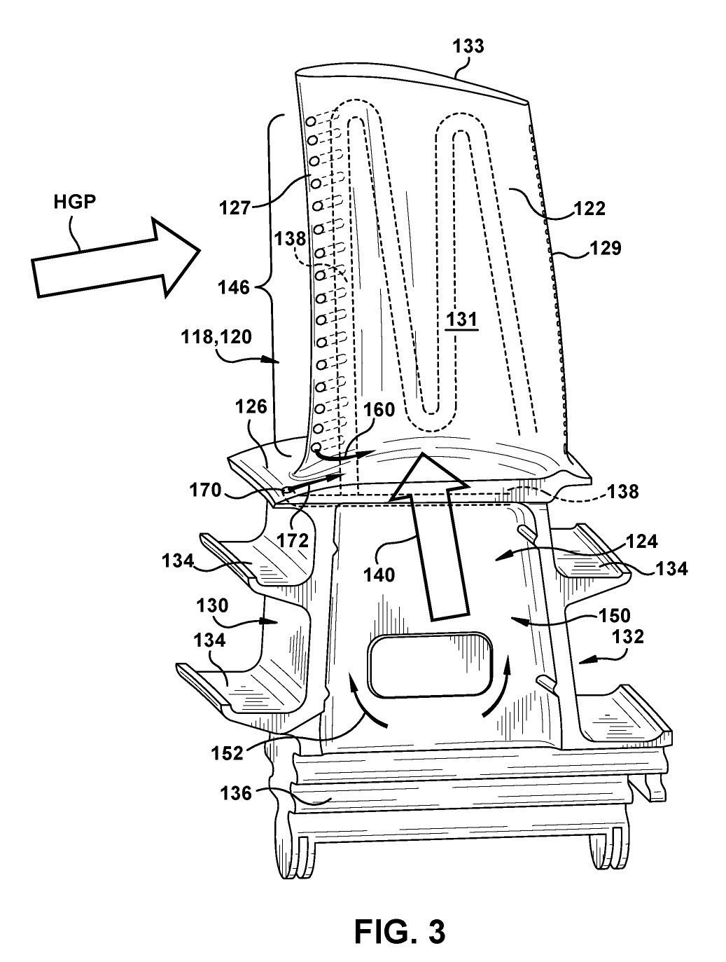

FIG. 3 shows a perspective view of an illustrative turbine blade 118 in the form of a turbine rotor blade 120 according to embodiments of the disclosure. Turbine rotor blade 120 may include airfoil 122 and shank 124. A platform 126 couples airfoil 122 to shank 124, and airfoil 122 extends radially from platform 126 above shank 124. Airfoil 122 includes a leading edge 127 and a trailing edge 129, and a pressure side wall 131 and a suction side wall 133 extending between the respective leading edge 127 and trailing edge 129. Shank 124 may include a pair of opposing cover plates 130, 132. Although not necessary, one or more angel wings 134 may optionally extend from each cover plate 130, 132.

As illustrated, airfoil 122 and/or platform 126 includes a cooling fluid chamber 138 (hereinafter “chamber 138”, in phantom) extending therein. Chamber 138 can carry a fluid 140 (arrow) to parts of blade 120 that is intended to reduce the temperature of the parts, or chamber 138 can be a dedicated passage to deliver a fluid 172 (from fluid 140) to exiting hole(s) 170, as described herein. In any event, fluid 140 can be provided in any now known or later developed fashion, e.g., pulled from a compressor 102 (FIG. 1) stream, an exhaust steam flow, etc., depending on the amount of fluid desired and the type of turbomachine employed. In some embodiments shown, chamber 138 may encompass a majority of an interior cross-sectional area, volume, etc., of airfoil 122 and/or platform 126. Chamber 138 can take a variety of forms within airfoils and/or platforms such as but not limited to: serpentine paths, multiple chambers, etc. It is also understood that airfoil 122 and/or platform 126 may also optionally include a variety of different structures (not shown for clarity) to distribute fluid 140 such as impingement sleeves, etc., prior to use according to embodiments of the disclosure. Airfoil 122 may also include a plurality of leading edge cooling openings 146 extending from chamber 138 in airfoil 122 through leading edge 127 of airfoil 122. In one embodiment, as illustrated, plurality of leading edge cooling openings 146 are radially spaced along leading edge 127 of airfoil 122. Equal radial spacing is not necessary in all cases. In any event, fluid 140 flows outward and then axially downstream along a selected side wall (depending on which side of leading edge 127 openings 146 open to) to cool airfoil 122, creating a boundary layer film 160 (shown only at hub/intersection of platform 126 and airfoil 122).

Various forms of connection to rotor 110 (FIGS. 1-2) may be applied depending on how turbine rotor blade 120 is employed. A connection tree 136 may be provided to couple turbine rotor blade 120 to a rotor wheel (not shown). As understood in the art, when mounted to a rotor wheel, adjacent turbine rotor blades 120 have a wheel space 150 therebetween. Wheel space 150 receives a fluid 152 similar to fluid 140 to, e.g., cool wheel space 150. Fluid 152, however, has a lower pressure than fluid 140. That is, chamber 138 is configured to deliver fluid 140 therein having a higher pressure than fluid 152 in wheel space 150 adjacent shank 124. In operation, fluid 152 escapes between platforms 126 of adjacent turbine rotor blades 120, i.e., as a purge flow. As fluid 152 has a lower momentum compared to boundary layer film 160, e.g., volume, velocity, flow rate, etc., it can disrupt boundary layer film 160 along a hub/intersection of airfoil 122 and platform 126. For example, on-boarding of wheel space 150 fluid 152 can drive boundary layer film 160 growth on the hub/intersection of blade 120, leading to a weaker boundary layer and stronger secondary losses.

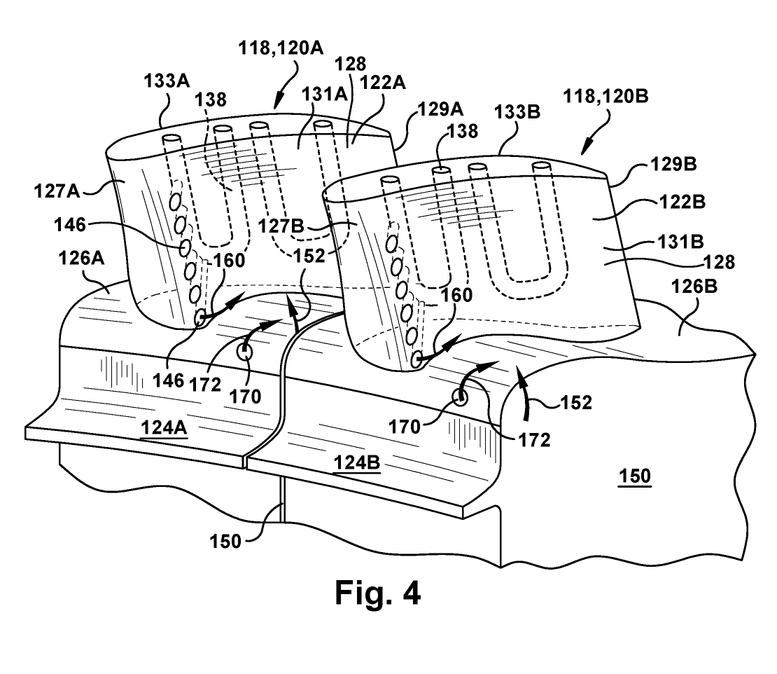

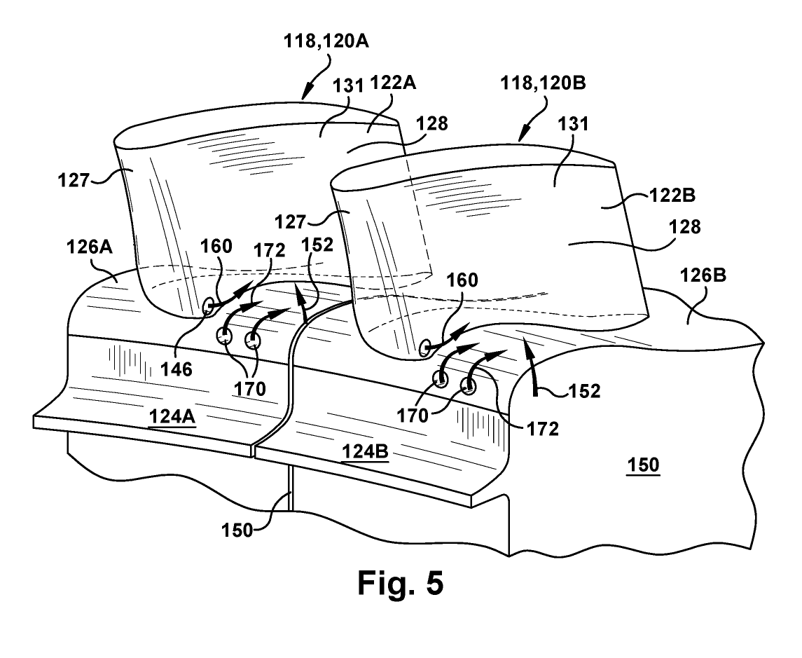

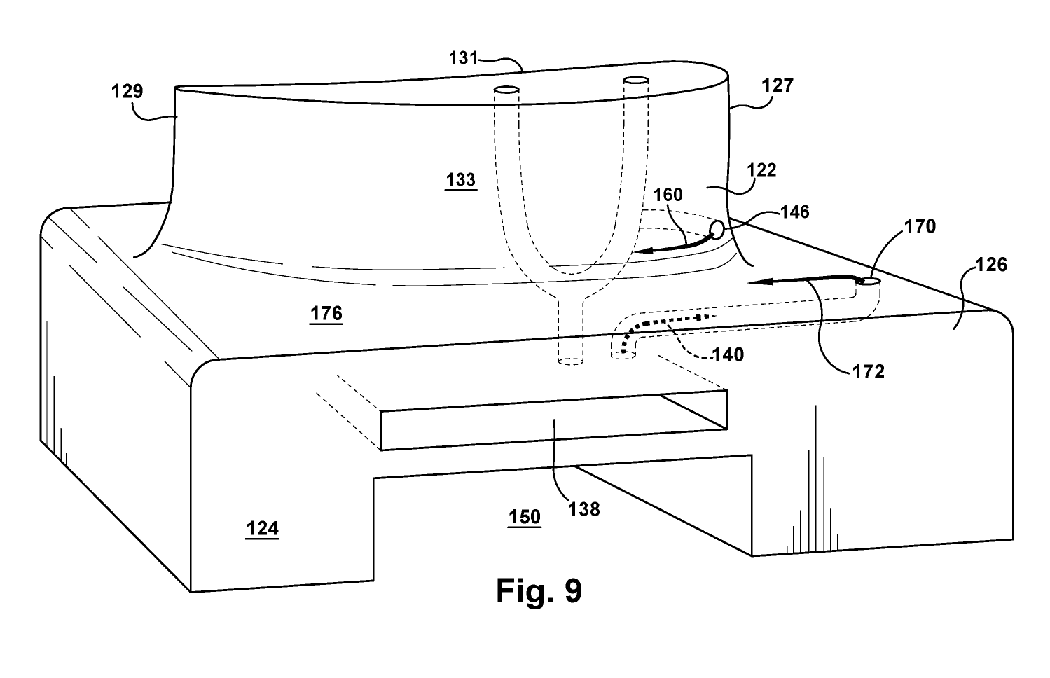

As shown in the partial perspective views of FIGS. 4 and 5, in order to address this situation, embodiments of the disclosure provide at least one exiting hole 170 at a location upstream of leading edge 127 (127A, 127B) and circumferentially to a side of selected side wall 128 of pressure side wall 131 and suction side wall 133. In FIGS. 4-8, selected side wall 128 includes pressure side wall 131 (131A, 131B), and in FIG. 9, selected side wall 128 includes suction side wall 133. Each exiting hole 170 is in fluid communication with chamber 138 to deliver fluid 172 (part of fluid 140) to boundary layer film 160. In this fashion, in operation, fluid 172 exits exiting hole(s) 170 to increase a momentum of boundary layer film 160 near selected side wall 128. Additional fluid 172 energizes boundary layer film 160 seeding locations, which can improve each stage's efficiency where employed. Fluid 172 thus counteracts the low momentum flow of fluid 152 escaping wheel space 150. Each exiting hole 170 is upstream of leading edge 127 such that fluid 172 exits and joins boundary layer film 160 prior to encountering a respective selected side wall 128. Each exiting hole 170 is circumferentially to a side of selected side wall 128. For example, in FIG. 4, exiting hole 170 in platform 126A above shank 124A is positioned such that fluid 172 exiting therefrom encounters pressure side wall 131A of airfoil 122A as part of boundary layer film 160 thereof, rather than suction side wall 133B of an adjacent airfoil 122B. The location relative to leading edge 127 and pressure side wall 131 can be customized based on a variety of parameters including but not limited to: the particular configurations of airfoils 122 and/or platforms 126, airfoil spacing, HGP pressure, boundary layer film 160 characteristics and/or fluid 172 characteristics. Similarly, in FIG. 9, exiting hole 170 in platform 126 above shank 124 is positioned such that fluid 172 exiting therefrom encounters suction side wall 133 of airfoil 122 as part of boundary layer film 160 thereof rather than pressure side wall 131 of an adjacent airfoil (not shown).

In FIG. 4, a single exiting hole 170 is provided for each turbine rotor blade 120A, 120B. In contrast in FIG. 5, a plurality of exiting holes 170 are provided. Each exiting hole 170 is in fluid communication with chamber 138 (FIG. 4), and is at a location upstream of a respective leading edge 127 and circumferentially to the side of a respective selected side wall 128. While two exiting holes 170 are shown in the example of FIG. 5, it will be appreciated that any number can be employed, e.g., 3, 4 or more.

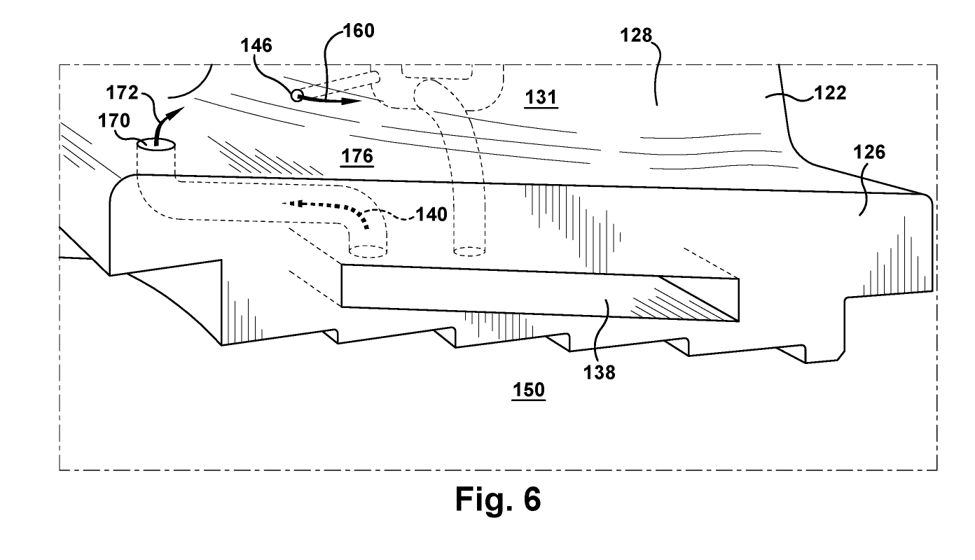

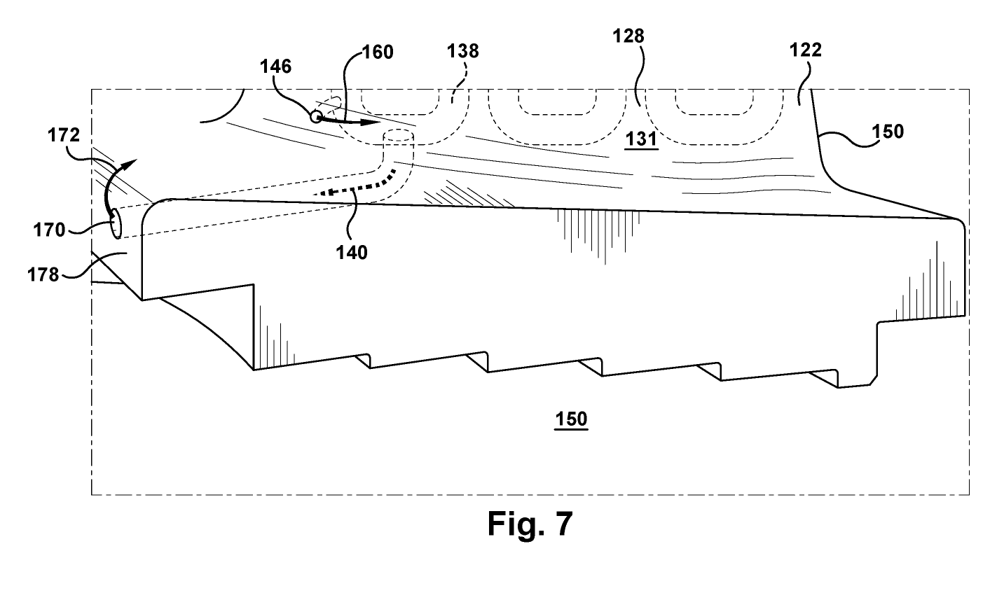

Exiting hole(s) 170 can be positioned on platform 126 in a number of axial locations, i.e., upstream of leading edge 127. As shown in the cross-sectional, perspective view of FIG. 6, an exiting hole 170 can be in an upper surface 176 of platform 126. FIG. 6 also shows an example of an exiting hole 170 in fluid communication with a chamber 138 in platform 126. Alternatively, as shown in the cross-sectional, perspective view of FIG. 7, an exiting hole 170 can be in a forward facing lip 178 of platform 126. FIG. 7 also shows an example of an exiting hole 170 in fluid communication with chamber 138 in airfoil 122. It will be appreciated that exiting hole(s) 170 having the FIG. 7 location can be in fluid communication with chamber 138 in platform 126 as in FIG. 6, and exiting hole(s) 170 having the FIG. 6 location can be in fluid communication with chamber 138 in airfoil 122 as in FIG. 7. Any form of fluid passage and fluid controls can be employed between chamber 138 and exiting hole(s) 170 including but not limited to: conduits, plenums, flow restrictors, flow disruptors (e.g., dimples, rough surfaces), etc.

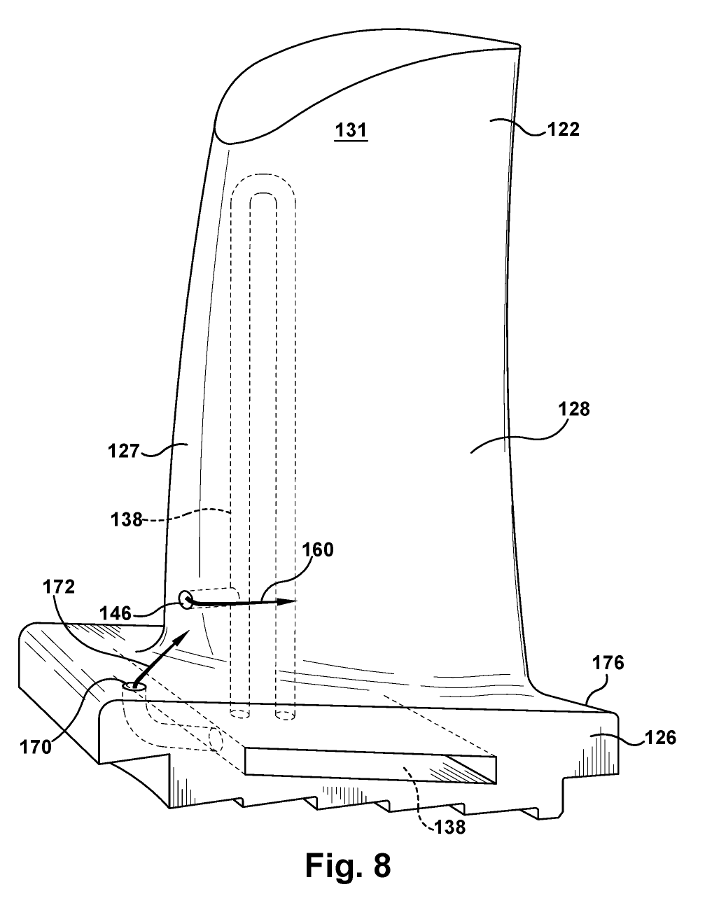

Exiting hole 170 can be configured to direct fluid 172 in any desired direction. For example, FIG. 8 shows an optional embodiment in which an exiting hole 170 (shown in phantom) is directed circumferentially at selected side wall 128, and FIG. 9 shows an optional embodiment in which an exiting hole 170 (shown in phantom) is directed downstream of leading edge 127. As will be understood, the FIGS. 8 and 9 embodiments can be combined. Exiting hole(s) 170 can be angled to direct fluid 172 in any desired direction. While shown relative to a single exiting hole 170, the teachings can be applied to any number of exiting holes 170. Where multiple exiting holes 170 are provided, they need not have the same angular configuration.

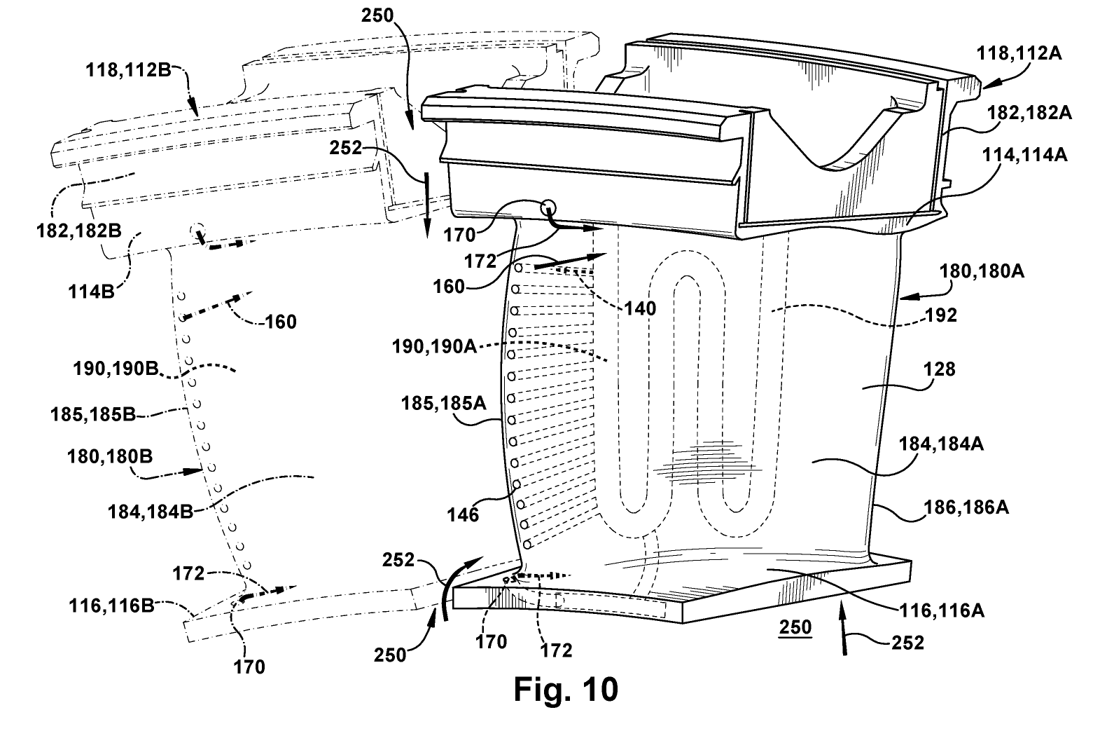

FIG. 10 shows a perspective view of turbine blade 118 in the form of a stationary vane 112 of the type in which embodiments of the present disclosure may be employed. Stationary vane 112 includes radially outer platform 114 by which stationary vane 112 attaches to stationary casing 109 (FIG. 2) of the turbomachine. Outer platform 114 may include any now known or later developed mounting configuration for mounting in a corresponding mount in casing 109 (FIG. 2). Where necessary, a shank 182 may extend from outer platform 114 for coupling to casing 109 (FIG. 2). Stationary vane 112 may further include radially inner platform 116 for positioning between platforms 126 (FIG. 3) of adjacent stages of turbine rotor blades 120 (FIGS. 2 and 3). Platforms 114, 116 define respective portions of the outboard and inboard boundary of the flow path through turbine 108. It will be appreciated that airfoil 180 of stationary vane 112 is the active component of stationary vane 112 that intercepts the flow of working fluid and directs it towards turbine rotor blades 120 (FIGS. 2 and 3). It will be seen in FIG. 10 that airfoil 180 of stationary vane 112 includes a concave pressure side (PS) outer side wall 184 and a circumferentially or laterally opposite convex suction side (SS) outer side wall 190 extending axially between opposite leading and trailing edges 185, 186, respectively. Side walls 184 and 186 also extend in the radial direction from platform 116 to platform 114. Either side wall 184, 186 can be a selected side wall 128, as described relative to turbine rotor blade 120.

As illustrated, airfoil 180 and/or platform(s) 114, 116 includes a cooling fluid chamber 192 (hereinafter “chamber 192”) extending therein. Chamber 192 can carry a fluid 140 (arrow) to parts of vane 112 that is intended to reduce the temperature of the parts, or chamber 192 can be a dedicated passage to deliver fluid 172 to exiting hole(s) 170, as described herein. In any event, fluid 140 can be provided in any now known or later developed fashion, e.g., pulled from a compressor 102 (FIG. 1) stream, an exhaust steam flow, etc., depending on the amount of fluid desired and the type of turbomachine employed. In some embodiments shown, chamber 192 may encompass a majority of an interior of airfoil 180 and/or platform(s) 114, 116. Chamber 192 can take a variety of forms within airfoils and/or platforms such as but not limited to: serpentine paths, multiple chambers, etc. It is also understood that airfoil 180 and/or platform(s) 114, 116 may also optionally include a variety of different structures (not shown for clarity) to distribute fluid 140 such as impingement sleeves, etc., prior to use according to embodiments of the disclosure. Airfoil 180 may also include a plurality of leading edge cooling openings 146 (similar to turbine rotor blade 120) extending from chamber 192 in airfoil 180 through leading edge 185 of airfoil 180. In one embodiment, as illustrated, plurality of leading edge cooling openings 146 are radially spaced along leading edge 185 of airfoil 180. Equal radial spacing is not necessary in all cases. In any event, fluid 140 flows outward and then axially downstream along selected side wall 128 (depending on which side of leading edge 185 they open to) to cool airfoil 180, creating a boundary layer film 160 (shown only at hub/intersection of platform 114 and airfoil 180).

Various forms of connection to casing 109 (FIG. 2) may be applied depending on how stationary vane 112 is employed. Similarly to turbine rotor blade 120, a connection tree (not shown) may be provided to couple stationary vane 112 to casing 109 (FIG. 2). As understood in the art, when mounted to casing 109 (FIG. 2), adjacent stationary vanes 112 have a wheel space 250 therebetween, i.e., between adjacent platforms 114 and/or platforms 116 (shown on both ends). Wheel spaces 250 receives a fluid 252 similar to fluid 140 to, e.g., cool wheel space(s) 250. Fluid 252, however, has a lower pressure than fluid 140. That is, chamber 192 is configured to deliver fluid 140 therein having a higher pressure than fluid 252 in wheel space(s) 250 adjacent platform(s) 114 and/or platform(s) 116. In operation, fluid 252 escapes between platforms 114, 116 of adjacent stationary vanes 112, i.e., as a purge flow. As fluid 252 has a lower momentum compared to boundary layer film 160, e.g., volume, velocity, flow rate, etc., it can disrupt boundary layer film 160 along a hub/intersection of airfoil 180 and platform(s) 114, 116. For example, on-boarding of wheel space 250 fluid 252 can drive boundary layer film 160 growth on the hub/intersection of vane 112, leading to a weaker boundary layer and stronger secondary losses.

As shown in FIG. 10, similar to FIGS. 4-9, in order to address this situation, embodiments of the disclosure provide at least one exiting hole 170 at a location upstream of leading edge 185 and circumferentially to a side of selected side wall 128 of pressure side wall 184 and suction side wall 186. In FIG. 10, selected side wall 128 includes pressure side wall 184, but as will be readily recognized, it can be applied to suction side wall 186, similar to the FIG. 9 embodiment. Each exiting hole 170 is in fluid communication with chamber 192 to deliver fluid 172 (part of fluid 140) to boundary layer film 160. As shown in phantom in FIG. 10, exiting hole(s) 170 can be applied to platform 116 in addition to, or alternatively, to platform 114. In this fashion, in operation, fluid 172 exits exiting hole(s) 170 to increase a momentum of boundary layer film 160 near selected side wall 128 at one or both platforms 114, 116. As noted, additional fluid 172 energizes boundary layer film 160 seeding locations, which can improve each stage's efficiency where employed. Fluid 172 thus counteracts the low momentum flow of fluid 252 escaping wheel space(s) 250. Each exiting hole 170 is upstream of leading edge 127 such that fluid 172 exits and joins boundary layer film 160 prior to encountering a respective selected side wall 128. Each exiting hole 170 as applied to turbine blade 118 in the form of stationary vane 112 may be positioned in any location as described relative turbine rotor blade 120 (FIGS. 4-9), e.g., any axial location, in radial face platform(s) 114, 116, forward facing lip of platform(s) 114, 116, etc. Further, any number of exiting hole(s) 170 may be applied. Any form of fluid passage and fluid controls can be employed between chamber 192 and exiting hole(s) 170 including but not limited to: conduits, plenums, flow restrictors, flow disruptors (e.g., dimples, rough surfaces), etc.

Exiting hole 170 as applied to stationary vane 112 can be configured to direct fluid 172 in any desired direction, e.g., directed circumferentially at selected side wall 128, and/or directed downstream of leading edge 185, angled to direct fluid 172 in any desired direction. The teachings can be applied to any number of exiting holes 170. Where multiple exiting holes 170 are provided, they need not have the same angular configuration.

As noted, embodiments of the disclosure described herein may include aspects applicable to either turbine rotor blade 120 and/or stationary vane 112. It is understood that other features of blade 120 or stationary vane 112, not described herein such as but not limited to internal cooling structures, cutout shape, outer wall angling/shape, etc., may be customized for the particular application, i.e., rotor blade or vane.

Referring to FIG. 1, gas turbine system 100 according to embodiments of the disclosure may include compressor 102, combustor 104 operatively coupled to compressor 102, and gas turbine 108 operatively coupled to compressor 102 and combustor 104. As shown for example in FIGS. 4 and 5 and FIG. 10, the gas turbine may include a number of turbine blades 118 including turbine rotor blades 120 and/or stationary vanes 112.

For example, in FIGS. 4 and 5, turbine blades 118 may include: a first turbine rotor blade 120A including first airfoil 122A extending radially from a first platform 126A and a first shank 124A. First airfoil 122A has a leading edge 127 and a trailing edge 129, and a pressure side wall 131A and a suction side wall 133A extending between the respective leading edge and trailing edge. Chamber 138 is positioned in at least one of first airfoil 122A and first platform 126A. Chamber 138 can be part of a cooling circuit in the airfoil(s) or a dedicated chamber. In any event, chamber 138 is configured to deliver a first fluid 140 (exiting as fluid 172) to exiting hole(s) 170. Exiting hole(s) 170 are in fluid communication with chamber 138. Exiting hole(s) 170 is at a location upstream of leading edge 127A and circumferentially to a side of the pressure side wall 131A.

Gas turbine 108 also includes a second turbine rotor blade 120B adjacent first turbine rotor blade 120A. Second turbine rotor blade 120B may include a second, adjacent airfoil 122B extending radially from a second platform 126B above a second shank 124B. Wheel space 150 is between respective shanks 124A, 124B of first and second turbine rotor blades 120A, 120B. Wheel space 150 may have a second fluid 152 therein having a pressure less than first fluid 140. As described, in operation, second fluid 152 escapes between first platform 126A and second platform 126B reducing a momentum of boundary layer film 160 near pressure side wall 131A (e.g., at the hub/intersection of airfoil 122 and platform 126). First fluid 172 exits exiting hole(s) 170 to increase the momentum of boundary layer film 160 near pressure side wall 131.

Referring to FIGS. 1 and 10, gas turbine system 100 (FIG. 1) according to other embodiments of the disclosure may include compressor 102, combustor 104 operatively coupled to compressor 102, and gas turbine 108 operatively coupled to compressor 102 and combustor 104. As shown for example in FIG. 10, the gas turbine may include a number of turbine blades 118 including stationary vanes including: a first stationary vane 112A including first airfoil 180A extending radially from a first platform 114A or 116A and a first shank 182A. First airfoil 180A has leading edge 185A and a trailing edge 186A, and pressure side wall 188A and suction side wall 190A extending between the respective leading edge and trailing edge. Chamber 192 is positioned in at least one of first airfoil 180A and first platform 114A or 116A. Chamber 192 can be part of a cooling circuit in the airfoil(s) or a dedicated chamber. In any event, chamber 192 is configured to deliver a first fluid 140 (exiting as fluid 172) to exiting hole(s) 170. That is, exiting hole(s) 170 are in fluid communication with chamber 192. Exiting hole(s) 170 is at a location upstream of leading edge 185A and circumferentially to a side of selected side wall 128 (shown as pressure side wall 188A).

Gas turbine 108 may also include a second stationary vane 112B adjacent first turbine stationary vane 112A. Second stationary vane 112B may include a second airfoil 180B extending radially from a second platform 114B or 116B and a second shank 182B. Wheel space 250 is between respective shanks 182A, 182B (radially outside of platforms 114A, 114B) and between platforms 116A, 116B of first and second stationary vanes 112A, 112B. Wheel space 250 may have a second fluid 252 therein having a pressure less than first fluid 140. As described, in operation, second fluid 252 escapes between first platform, e.g., 114A, and second platform, e.g., 114B, reducing a momentum of boundary layer film 160 near selected side wall 128 (e.g., at the hub/intersection of airfoil 180A and platform 114). Second fluid 252 may also escape between adjacent second platforms 116A, 116B. First fluid 172 exits exiting hole(s) 170 to increase the momentum of boundary layer film 160 near selected side wall 128, e.g., pressure side wall 184A. It is understood that exit hole(s) 170 can also be present in platform(s) 116 (in phantom in FIG. 10) in addition to platform(s) 114 or alternatively thereto.

While turbine rotor blades 120 and stationary vanes 112 within a particular stage of gas turbine 108 have been shown as identical, it is emphasized that each rotor blade or vane may be customized for its particular circumferential location. Further turbine blades 118 for a particular stage can be customized for their particular axial location within gas turbine 108, e.g., blades of one stage can be different than blades of another stage.

As indicated above, embodiments of the disclosure provide a mechanism to address on-boarding of wheel space purge flow of fluid that drives boundary layer film growth on the platform (hub) of a turbine blade, leading to a weaker boundary layer and stronger secondary losses. Embodiments of the disclosure inject additional flow of fluid to energize boundary layer film seeding locations, which can improve each stage's efficiency where employed. The additional fluid improves the creation of an effective boundary layer cooling flow, and reduces the tendency for the cooling flow exiting the airfoil near a leading edge to flow toward the suction side of the airfoil and radially outward away from the platform. Similarly, the additional fluid reduces the tendency of hotter cooling flow on the pressure side to flow radially inward toward the platform. Each of these situations results in better cooling flow for the airfoil and the platform. Further, the additional fluid reduces the disruption of coolant escaping from the wheel space to the boundary layer cooling flow, which allows better maintenance of flow momentum, and improved cooling effectiveness. Consequently, the additional fluid improves cooling but without additional amounts of coolant and/or reduced boundary layer cooling flow energy. Thus, embodiments of the disclosure can positively impact turbine performance, e.g., by decreasing a heat rate thereof and/or increasing efficiency. Furthermore, embodiments of the disclosure can increase the longevity of turbine blades.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise. “Approximately” as applied to a particular value of a range applies to both values, and unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A turbine blade, comprising:
an airfoil extending radially from a platform above a shank, the airfoil having a leading edge and a trailing edge, a pressure side wall extending between the leading edge and the trailing edge and a suction side wall extending between the leading edge and the trailing edge;
a chamber in at least one of the airfoil and the platform, the chamber configured to deliver a first fluid therein having a higher pressure than a second fluid in a wheel space adjacent the shank; and
an exiting hole in fluid communication with the chamber, the exiting hole at a location upstream of the leading edge and circumferentially to a side of a selected side wall of one of the pressure side wall or the suction side wall,
wherein, in operation, the first fluid exits the exiting hole to increase a momentum of a boundary layer film near the selected side wall.

2. The turbine blade of claim 1, wherein the exiting hole includes a plurality of exiting holes, each exiting hole in fluid communication with the chamber and at a location upstream of the leading edge and circumferentially to the side of the selected side wall.

3. The turbine blade of claim 1, wherein the exiting hole is in an upper surface of the platform.

4. The turbine blade of claim 1, wherein the exiting hole is in a forward facing lip of the platform.

5. The turbine blade of claim 1, wherein the exiting hole is directed at the selected side wall downstream of the leading edge.

6. The turbine blade of claim 1, wherein the chamber is in the platform.

7. The turbine blade of claim 1, wherein the chamber is in the airfoil.

8. A gas turbine system, comprising:
a compressor;
a combustor operatively coupled to the compressor;
a gas turbine operatively coupled to the compressor and the combustor, the gas turbine including:
a first turbine blade, the first turbine blade including:
a first airfoil extending radially from a first platform and a first shank, the first airfoil having a leading edge and a trailing edge, a pressure side wall extending between the respective leading edge and trailing edge, and a suction side wall extending between the respective leading edge and trailing edge,
a chamber in at least one of the first airfoil and the first platform, the chamber configured to deliver a first fluid therein,
an exiting hole in fluid communication with the chamber, the exiting hole at a location upstream of the leading edge and circumferentially to a side of a selected side wall of one of the pressure side wall and the suction side wall; and
a second turbine blade adjacent the first turbine blade, the second turbine blade including a second airfoil extending radially from a second platform above a second shank; and
a wheel space between respective shanks of the first and second turbine blades, the wheel space having a second fluid therein having a pressure less than the first fluid,
wherein, in operation, the second fluid escapes between the first platform and the second platform reducing a momentum of a boundary layer film near a selected side wall of the pressure side wall and the suction side wall, and the first fluid exits the exiting hole to increase the momentum of the boundary layer film near the selected side wall.

9. The gas turbine system of claim 8, wherein the exiting hole includes a plurality of exiting holes, each exiting hole in fluid communication with the chamber and at a location upstream of the leading edge and circumferentially to the side of the selected side wall.

10. The gas turbine system of claim 8, wherein the exiting hole is in an upper surface of the first platform.

11. The gas turbine system of claim 8, wherein the exiting hole is in a forward facing lip of the first platform.

12. The gas turbine system of claim 8, wherein the exiting hole is directed at the selected side wall of the first airfoil downstream of the leading edge.

13. The gas turbine system of claim 8, wherein the chamber is in the first platform.

14. The gas turbine system of claim 8, wherein the chamber is in the first airfoil.
